(19) United States
(12) Patent Application Publication
(10) Pub. No.: US 2026/0342123 A1
(43) Pub. Date: Oct. 29, 2026

(54) Discharging at Least one Battery via Discharge Apparatus Having a Plurality of Battery Connection Points Arranged in Series

(71) Applicant: Siemens Aktiengesellschaft, Muenchen (DE)

(72) Inventors: Arno ARZBERGER, Erlangen (DE); Julian PETZ, Erlangen (DE); Lukas BELLUT, Erlangen (DE); Daniel LEINMÜLLER, München (DE); Dominik BUDDAY, Erlangen (DE); Arthur SCHMID, München (DE); Simon HEISE, Erlangen (DE); Patricia BERLT, Erlangen (DE)

(21) Appl. No.: 19/631,901

(22) Filed: Mar. 27, 2026

(30) Foreign Application Priority Data
Mar. 31, 2025 (EP) 25167488

(51) Int. Cl. H02J 7/96; H01M 10/44; H02J 7/50; H02J 7/60; H02J 7/90

(52) U.S. Cl. CPC H02J 7/96; H01M 10/44; H02J 7/50; H02J 7/60; H02J 7/977

(57) ABSTRACT

A method for discharging at least one battery via a discharge apparatus, wherein the discharge apparatus comprises a plurality of battery connection points arranged in series, and to the discharge apparatus.

### BACKGROUND OF THE INVENTION

### 1. Field of the Invention

The invention relates to a discharge apparatus and a method for discharging at least one battery via the discharge apparatus, where the discharge apparatus comprises a plurality of battery connection points arranged in series.

### 2. Description of the Related Art

In view of the increasing use of batteries in electrical devices and electric vehicles, safe and efficient recycling of batteries is becoming increasingly important. An essential step in the recycling process is the complete discharge of the batteries, because this minimizes a large number of safety-relevant hazards, including fire risks, hazardous touch voltages, arcing, release of toxic gases, and burns caused by overheating.

Complete discharge reduces the risk of fire. An internal or external short circuit of a charged battery can release sufficient heat to ignite the battery itself (thermal runaway) or adjacent combustible materials. Voltages hazardous to touch must also be prevented. In the e-mobility sector, a voltage in excess of 60 V DC is already regarded as being in the “high-voltage range”. Above this voltage, repair, testing, and maintenance work on drive components may only be performed by persons qualified to work on high-voltage systems or by persons instructed by qualified personnel under the supervision and direction of a person qualified to work on high-voltage systems (cf. DGUV Rule 109-009: Vehicle maintenance, section 7.2). Due to thermal effects, an internal or external short circuit of a charged battery can also result in such a large increase in the internal pressure in the battery cells that hot electrolyte vapors or combustion gases escape at high velocity. The vapors or gases may be acutely toxic and/or carcinogenic. In addition, burns must be prevented: in the event of internal or external short circuits, the surfaces of batteries that have not been discharged may heat up to such an extent that contact may result in burns to the skin.

Accidental arcing may occur in the context of batteries that are to be recycled and have not yet been discharged, in particular due to short-circuiting of the battery terminals or in the event of insulation faults, and the arcing must therefore likewise be avoided. Batteries can produce extremely powerful arcs. These can cause burns, hearing damage, inhalation of hazardous metal vapors, and flash injuries to the eyes.

Passive discharge methods are known, such as connecting an electrical resistor or immersing the battery in an electrically conductive liquid. Passive discharge methods are often less suitable for industrial applications due to their limited controllability and because the electrical energy cannot be utilized.

Active discharge methods, on the other hand, allow control of the discharge process and continued use of the converted electrical energy, for example, for feeding into the public power grid or for local storage.

EP 4 179 605 B1 discloses an apparatus and method via which discharged batteries can be removed from a series connection and new batteries to be discharged can be inserted into the series connection.

### SUMMARY OF THE INVENTION

In view of the foregoing, it is an object of the present invention to provide and device and method that enable safe and efficient discharge of batteries, particularly in a series connection, where electrical safety risks, in particular hazardous touch voltages and short-circuit risks, are minimized while at the same time process stability and efficiency are increased.

These and other objects and advantages are achieved in accordance with the invention by a method for discharging at least one battery via a discharge apparatus comprising a plurality of battery connection points arranged in series.

The method comprises connecting the battery to a vacant battery connection point, where the vacant battery connection point is disconnected, at all poles, from a discharge circuit of the discharge apparatus by means of an open switch and a changeover switch in a first position. The method further incldues ramping down a current in the discharge circuit, switching the changeover switch to a second position so that, instead of a connection in the discharge apparatus parallel to and bypassing the battery connection point, a connection from and/or to a first pole of the battery connection point becomes capable of carrying current, closing the switch so that a connection in the discharge apparatus from and/or to a second pole of the battery connection point becomes capable of carrying current, discharging the connected battery via a discharge current provided by a controller of the discharge apparatus, ramping down the current in the discharge circuit, and opening the switch.

The method additioally includes switching the changeover switch to the first position so that, instead of the connection from and/or to the first pole of the battery connection point, the connection in the discharge apparatus parallel to and bypassing the battery connection point becomes capable of carrying current, and providing the discharged battery.

The discharge apparatus with its plurality of battery connection points arranged in series makes it possible for batteries to be connected in series during active discharging. Particularly for recycling operations that process a large number of battery types with differing voltages and capacities, the power electronics that must be provided for the discharging process are thus optimally utilized.

A battery to be discharged is inserted into a vacant battery connection point while the circuit section containing the battery connection point, where the corresponding plug connections and in particular further components, such as a voltage measuring device, is disconnected at all poles from a discharge circuit of the discharge apparatus. In this way, any desired number of further batteries inserted in other battery connection points can be discharged flexibly while a battery to be discharged is inserted into the vacant battery connection point that is disconnected at all poles. A battery connection point may also advantageously remain vacant without affecting a discharge process of other batteries.

The discharge process can now proceed with the battery to be discharged inserted in the connection point. For this purpose, the discharge current in the discharge circuit is ramped down at least briefly, for example, to a target value of approximately zero amperes. The changeover switch is then switched to a second position so that, instead of a connection in the discharge apparatus parallel to and bypassing the battery connection point, a connection from and/or to a first pole of the battery connection point becomes capable of carrying current.

The switch is likewise closed so that a connection in the discharge apparatus from and/or to a second pole of the battery connection point becomes capable of carrying current.

The battery connection point then becomes part of the discharge circuit. The circuit section containing the battery connection point together with the changeover switch, the switch and the short-circuit switch is also referred to as a “sub-channel”. The sub-channel is switched into the discharge circuit by closing the switch and switching the changeover switch to the second position. Instead of a connection in the discharge apparatus parallel to and bypassing the battery connection point, which can also be referred to as a battery connection bypass, the connections to the battery connection point are then capable of carrying current.

Capable of carrying current means in particular that current is carried once a power supply is connected or voltage is applied. The connected battery is then discharged via a discharge current. In particular, a discharge current is specified by the controller of the discharge apparatus. The discharge current thus flows through the sub-channel. For this purpose, the current in the discharge circuit is ramped up, which in particular also includes taking into account a voltage measured across the inserted battery. For example, the sub-channel remains part of the discharge circuit until a particular limit value is reached as a lower limit for the residual voltage in the battery. A signal is then given to the controller, for example, indicating that the sub-channel in which the remaining residual voltage has fallen below the limit value is to be switched out of the discharge circuit.

For example, the residual voltage present in the battery is measured and the battery is discharged with a discharge current value specified by the controller as a setpoint. For example, a target voltage is set and the battery is discharged, taking into account limitations imposed, for example, by the electronics and/or temperature monitoring. For this purpose, for example, the temperature of a respective battery is measured and monitored on a per sub-channel basis.

The limit value for the battery voltage is in particular zero volts or approximately zero volts. In embodiments, the limit value is negative so that deactivation of the battery can be achieved.

For switching the sub-channel out, the discharge current is ramped down. The switch to the second pole is then opened so that the battery is removed from the discharge circuit. The changeover switch is returned to the first position so that, instead of the connection from and/or to the first pole of the battery connection point, the connection in the discharge apparatus parallel to and bypassing the battery connection point becomes capable of carrying current, and the battery connection bypass thus carries current once the discharge current is ramped up again. The battery is now disconnected at all poles.

The fully discharged battery is now available and can be removed. Flexible operation without affecting the discharge process of the remaining batteries in the series connection when a discharged battery is removed and when a new battery to be discharged is inserted is advantageously ensured. Moreover, discharged batteries can be safely short-circuited independently of the ongoing process.

By using an active discharge method, batteries are advantageously discharged flexibly either individually or in a series connection via suitable power electronics, such as an electronically controlled load. Advantageously, converted electrical energy is continued to be used, for example, stored locally or fed back into the public power grid. In order to operate active discharge economically, the electrical design of the power electronics, primarily characterized by permissible current and voltage ranges, is adapted to suit the batteries to be recycled.

For a recycling operation in which a large variety of battery types with widely differing voltage levels are processed, a plurality of batteries can advantageously be connected in series and discharged simultaneously via suitable power electronics, a so-called channel. By virtue of the series connection, the voltages of the individual batteries are added together, whereby the number of channels to be provided can be minimized by optimally utilizing the maximum voltage of the power electronics.

In accordance with one embodiment, the method further comprises ramping up the current in the discharge circuit to a discharge current value after the changeover switch has been switched to the first position. In particular, the current is ramped up once the changeover switch is in the first position, since from that point onward the discharge current is to be conducted through the sub-channel circuit to discharge the battery.

In accordance with one embodiment, the method further comprises closing a short-circuit switch so that a short-circuit path of the battery connection point establishes a short circuit between battery contacts of the connected battery. Moreover, a short-circuit switch provided within the sub-channel is now closed, thereby establishing a short circuit between battery contacts of the connected battery. The battery is now short-circuited; the short-circuit path is formed within the sub-channel after the battery has been disconnected at all poles.

Advantageously, process disturbances and impairment of system safety caused by the short-circuiting of the battery during operation of the apparatus are avoided, because the short-circuiting occurs independently of the discharge circuit after a sub-channel has been disconnected from it.

In addition, for example, after short-circuiting by means of the short-circuit switch, a short-circuit wire is externally attached which then ensures a permanent short circuit even outside the installation.

In accordance with a further embodiment, the battery is deactivated. The limit value for the battery voltage is then negative, so that deactivation of the battery can be achieved. The “pole swap” and further discharging into negative voltage ranges result in an internal short circuit of the battery. The battery connection point is then disconnected at all poles. During removal, voltages hazardous to touch are advantageously prevented, because no voltage that is hazardous to touch is present at any of the poles when a battery is replaced.

A short-circuit switch of the above-described type can additionally be actuated for deactivation.

In accordance with another embodiment, the provided battery is removed. For example, the removal is acknowledged. For example, LEDs at the battery connection point indicate when it is safe to remove the battery, in particular when the battery has been discharged, the voltage has fallen below a threshold value, and, in addition, the short-circuit switch has been closed.

In accordance with yet another embodiment, once the battery has been removed, the short-circuit switch is opened and the method is repeated using the above steps. In this state, the battery connection point is not part of the discharge circuit through which current flows, and a short circuit of a battery to be inserted is prevented because the short-circuit switch was opened beforehand.

In accordance with one embodiment, switching the changeover switch to the second position and closing the switch are performed simultaneously. Switching of the sub-channel into the discharge circuit is possible via the changeover switch and the switch, in particular when the switching is performed simultaneously.

In accordance with another embodiment, opening the switch and switching the changeover switch to the first position are carried out sequentially. The “switching out” from the discharge circuit occurs in particular when the battery has been sufficiently discharged. By opening the switch, the battery is already removed from the discharge circuit; by switching the changeover switch to the first position, the battery is then disconnected at all poles.

In accordance with a still further embodiment, the voltage of the battery to be discharged is measured, after the battery has been connected, via a voltage measuring device, and the further steps are performed depending on the voltage measured. For example, a battery inserted at the battery connection point is continuously measured during the ongoing operation to determine a residual voltage. For example, all the steps subsequent to connection and voltage measurement are performed only if the residual voltage of the inserted battery is above a threshold value. Otherwise, for example, the LEDs in turn indicate that the battery is already sufficiently discharged and the sub-channel is not switched into the discharge circuit. However, if the voltage is not below the threshold value, the current is ramped down for the subsequent “switching in” of the sub-channel.

In particular, the voltage also continues to be measured during discharging, so that the discharge process can be terminated for each sub-channel once the residual voltage in the battery is sufficiently low. For embodiments involving pole swap and negative discharge, a negative threshold value up to which the battery is discharged negatively is used. Based on the voltage measurement, it is monitored when the internal short circuit has been effected, so that the battery can then be switched out.

In accordance with one embodiment, the temperature of the battery to be discharged is measured via a temperature measuring device once the battery is connected, and the further steps are performed depending on the temperature measured. In particular, the temperature is continuously measured during deactivation and the deactivation is interrupted if an excessive temperature rise is detected. For example, the battery or the battery environment is then first cooled and the deactivation process is restarted.

The objects and advantages are also achieved in accordance with the invention by a discharge apparatus having a plurality of battery connection points arranged in series for discharging at least one battery, in particular for discharging a plurality of batteries simultaneously, having a controller and, for each battery connection point, a switch, a changeover switch, and a short-circuit switch, the discharge apparatus being designed and configured to perform the method in accordance with the disclosed embodiments. For example, up to ten battery connection points may be provided for each controller of the discharge apparatus.

In accordance with an embodiment, the discharge apparatus further has a voltage measuring device for each battery connection point.

In accordance with another embodiment, the discharge apparatus further has a temperature measuring device for each battery connection point.

The objects and advantages are further achieved in accordance with the invention by a discharge apparatus having a plurality of battery connection points arranged in series for discharging at least one battery, in particular for discharging a plurality of batteries simultaneously, where a switch arrangement for connecting and/or disconnecting an inserted battery at all poles is provided for each battery connection point. Disconnecting the battery connection point from the discharge circuit at all poles makes it possible to safely remove the battery from the connection point.

In accordance with another embodiment, the discharge apparatus further has, for each battery connection point, a short-circuit switch for short-circuiting an inserted battery that has been discharged and disconnected at all poles. By short-circuiting the battery, once it has been discharged below a definable residual voltage, via a separate short-circuit path and independently of the discharge circuit and the other sub-channels located therein, the short-circuiting occurs without affecting any discharge process that may still be ongoing, and enables safe removal of the battery from the connection point.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be explained in more detail on the basis of exemplary embodiments and with the aid of the figures, in which:

FIG. 1 shows a schematic illustration of a discharge apparatus in accordance with an exemplary embodiment;

FIG. 2 shows a schematic representation of a section of the discharge apparatus of FIG. 1;

FIG. 3 is a flowchart of the method in accordance with the invention.

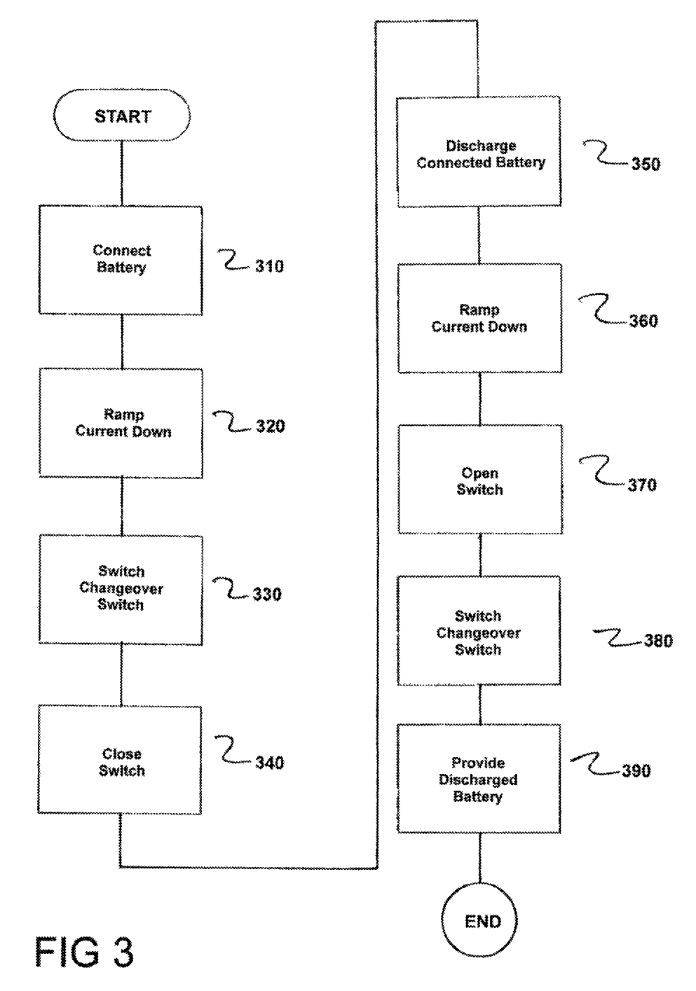

### DETAILED DESCRIPTION OF THE EXEMPLARY EMBODIMENTS

In the figures, elements having the same function are provided with the same reference characters unless otherwise indicated.

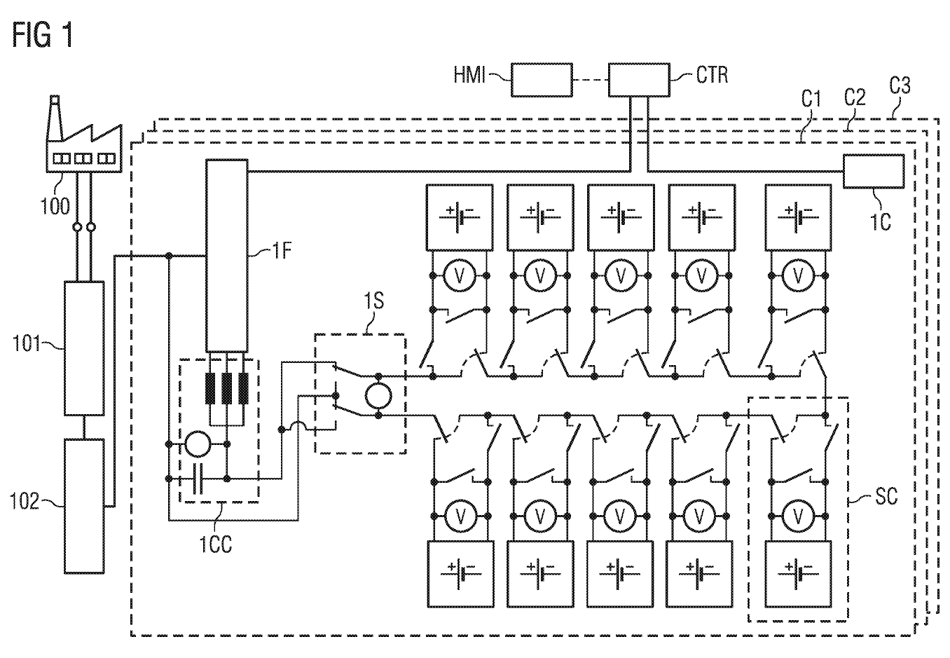

FIG. 1 shows a simplified circuit diagram of a discharge apparatus in accordance with an exemplary embodiment of the invention. The discharge apparatus comprises three so-called “channels” C1, C2, C3 for discharging a plurality of batteries and is connected, for example, to a factory power grid 100 via an intelligent power distribution unit 102 and a transformer 101. In accordance with the exemplary embodiment, the discharge apparatus is established for preparing batteries for recycling and is physically integrated into an automation system for dismantling batteries, so that the energy extracted from the batteries can advantageously be fed into the factory power grid 100. The batteries arrive at the recycling facility with unknown and initially undetermined residual capacity and, for example, after sorting according to battery types and/or connection types, are first discharged in the discharge apparatus.

For example, batteries to be recycled are discharged in the discharge apparatus and removed once complete discharge is indicated, for example, by LEDs or comparable indicators at the battery connection points, or via an huamn-machine interface (HMI) of a controller that visualizes the channels with their associated battery connection points. In real-world operation, the batteries will almost never reach the fully discharged state simultaneously. This is because the batteries are connected in series and the same current flows through all the batteries, but the capacity to be discharged is not uniform. Reasons for differing capacities include, for example, different initial states of charge (SOC), different nominal capacities, and/or different degrees of aging.

For example, ten “sub-channels” SC are provided in channel C1, one of which is indicated in FIG. 1 by way of illustration. Channel C1 as a whole is switched via a main switching unit 1S so that it serves, on the one hand, to discharge batteries inserted in the sub-channels SC and, on the other hand, to simultaneously feed energy into the factory power grid 100. Control is effected via a control unit CTR that provides corresponding signals with setpoints for each channel, for example C1. Power to be fed into the factory power grid 100 is prepared via a grid filter component 1CC comprising inductors and capacitors and via a voltage converter 1F.

For example, all the channels C1, C2, C3 are of similar configuration, each comprising a control unit. In certain embodiments, a higher-level control unit is provided for controlling all the channels. For example, a programmable logic controller (PLC) is used and a human–machine interface (HMI) is provided as an interface for operating personnel.

For example, for each channel C1 a cooling component 1C can also be installed, which detects excessively high temperatures for each channel C1 and - controlled by the control unit CTR - counteracts this via air cooling.

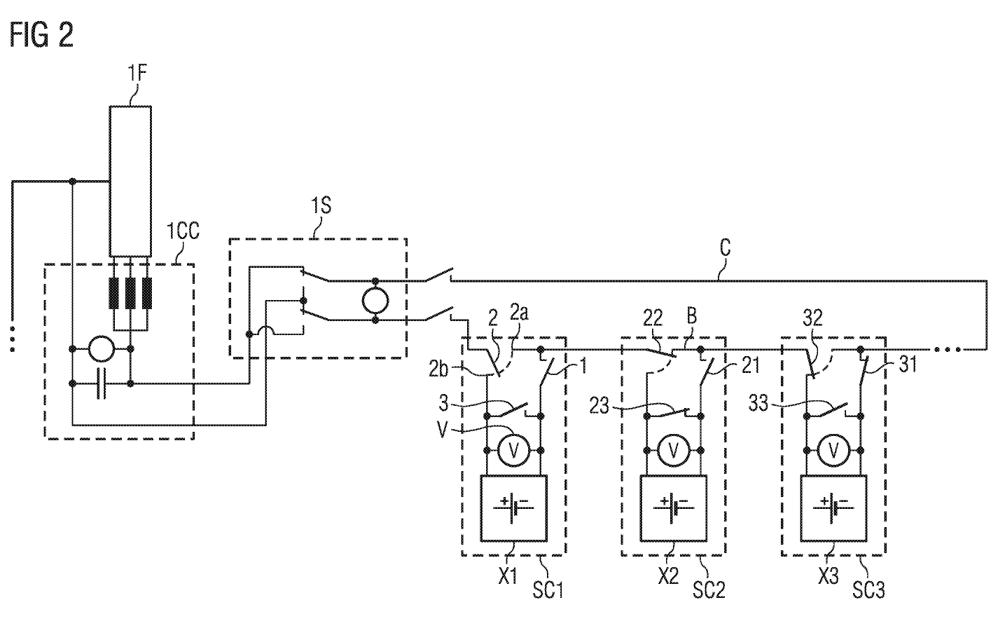

The discharging functionality for each sub-channel SC1, SC2, SC3 is explained with reference to FIG. 2. Shown in sub-channel SC1 by way of example are the relevant switching components that enable the battery to be disconnected at all poles at connection point X1 and also enable the inserted battery, once discharged, to be short-circuited outside a discharge circuit C for the remaining sub-channels. A switch 1 is provided which, when opened, causes the battery connection point X1 to no longer form part of the discharge circuit, i.e., the controlled discharge process is interrupted. By switching a changeover switch 2 from a second position 2b to a first position 2a, the battery connection point X1 is disconnected from the discharge circuit C at all poles. A short-circuit switch 3 is additionally provided for each sub-channel and causes the battery poles of an inserted battery to be short-circuited.

Sub-channels SC2 and SC3 are now used to explain how the switching components interact. The changeover switch 22 is in a first position and the switch 21 is open. The battery connection point X2 is therefore not involved in the discharging operation, irrespective of whether or not a battery is inserted. The connection B bypassing the battery connection point can be regarded as a bypass that excludes the entire sub-channel SC2 from the discharging operation carried out via the controller.

In this switch position in sub-channel SC2, the short-circuit switch 23 is preferably also closed after a battery has been discharged and during removal of the discharged battery. This prevents residual voltages in the battery from presenting a danger to operating personnel during removal. Before the next battery to be discharged is inserted, the short-circuit switch is opened again.

Using the proposed discharge apparatus, the batteries are discharged flexibly and independently of the discharging of other batteries in the same channel or in other channels. Once a desired state of a battery has been reached, for example, 0% SOC or 0 volts, the battery is removed. In order to avoid falling below a minimum permissible voltage of the power electronics, it may also be necessary to monitor the removal of the relevant batteries in a channel in combination and, for example, to selectively insert additional batteries to be recycled into the series connection in order to increase the total voltage.

The switch position in sub-channel SC3 causes a battery present in this sub-channel SC3 to be discharged. For this purpose, switch 31 is closed and changeover switch 32 is in the second position, so that in this sub-channel SC3 the bypass is not used but instead the discharge circuit C includes the battery connection point X3.

The inventive circuit, together with the inventive method, increases the electrical safety of the installation. By using switch 1 and changeover switch 2 for all-pole disconnection, the risk of an unintended battery short circuit is significantly reduced compared to the prior art. In addition, short-circuiting of the battery can be performed entirely independently of the process, for example, after the battery has first been completely discharged to 0 V and then removed from the series connection. This ensures complete absence of interaction with the batteries remaining in the series connection. The combination of all-pole disconnection and short-circuiting enables the operator, in this electrically isolated condition and if required, to safely attach an external short-circuit bridge in order to prevent a relaxation voltage in the battery, without having to interrupt the discharge process for the other batteries in the series connection.

FIG. 4 is a flowchart of the method for discharging at least one battery via a discharge apparatus including a plurality of battery connection points X1, … arranged in series.

The method comprises connecting the battery to a vacant battery connection point X1, …, as indicated in step 410. Here, the vacant battery connection point X1, … is disconnected, at all poles, from a discharge circuit C of the discharge apparatus via an open switch 1 and a changeover switch 2 in a first position 2a.

Next, the current in the discharge circuit C is ramped down, as indicated in step 420.

Next, the changeover switch 2 is switched to a second position 2b such that, instead of a connection B in the discharge apparatus parallel to and bypassing the battery connection point X1, …, a connection at least one of from and to a first pole of the battery connection point X1, … becomes enabled to carry current, as indicated in step 430.

Next, the switch 1 is closed such that a connection in the discharge apparatus at least one of from and to a second pole of the battery connection point X1, … becomes enabled to carry current, as indicated in step 440.

Next, the connected battery is discharged via a discharge current provided by a controller CTR of the discharge apparatus, as indicated in step 450.

Next, the current in the discharge circuit C is ramped down, as indicated in step 460.

The switch 1 is now opened, as indicated in step 470.

Next, the changeover switch 2 is switched to the first position 2a such that, instead of the connection B at least one of from and to the first pole of the battery connection point X1, …, the connection in the discharge apparatus parallel to and bypassing the battery connection point X1, … becomes enabled to carry current, as indicated in step 480.

A discharged battery is now provided, as indicated in step 490.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for discharging at least one battery via a discharge apparatus including a plurality of battery connection points arranged in series, the method comprising:
connecting the battery to a vacant battery connection point, the vacant battery connection point being disconnected, at all poles, from a discharge circuit of the discharge apparatus via an open switch and a changeover switch in a first position;
ramping down a current in the discharge circuit;
switching the changeover switch to a second position such that, instead of a connection in the discharge apparatus parallel to and bypassing the battery connection point, a connection at least one of from and to a first pole of the battery connection point becomes enabled to carry current;
closing the switch such that a connection in the discharge apparatus at least one of from and to a second pole of the battery connection point becomes enabled to carry current;
discharging the connected battery via a discharge current provided by a controller of the discharge apparatus;
ramping down the current in the discharge circuit;
opening the switch;
switching the changeover switch to the first position such that, instead of the connection at least one of from and to the first pole of the battery connection point, the connection in the discharge apparatus parallel to and bypassing the battery connection point becomes enabled to carry current; and
providing the discharged battery.

2. The method as claimed in claim 1, further comprising:
ramping up the current in the discharge circuit to a discharge current value once the changeover switch is switched to the first position.

3. The method as claimed in claim 1, further comprising:
closing a short-circuit switch such that a short-circuit path of the battery connection point establishes a short circuit between battery contacts of the connected battery.

4. The method as claimed in claim 2, further comprising:
closing a short-circuit switch such that a short-circuit path of the battery connection point establishes a short circuit between battery contacts of the connected battery.

5. The method as claimed in claim 1, further comprising:
performing deactivation of the battery.

6. The method as claimed in claim 1, wherein the provided battery is removed.

7. The method as claimed in claim 3, further comprising:
opening the short-circuit switch; and
repeating the method.

8. The method as claimed in claim 5, further comprising:
opening the short-circuit switch; and
repeating the method.

9. The method as claimed in claim 6, further comprising:
opening the short-circuit switch; and
repeating the method.

10. The method as claimed in claim 1, wherein switching of the changeover switch to the second position and closing of the switch are performed simultaneously.

11. The method as claimed in claim 1, wherein opening the switch and switching the changeover switch to the first position are performed sequentially.

12. The method as claimed in claim 1 wherein, once the battery is connected, a voltage of the battery to be discharged is measured via a voltage measuring device and the further steps are performed depending on the voltage measured.

13. The method as claimed in claim 1, wherein, once the battery is connected, a temperature of the battery to be discharged is measured via a temperature measuring device and the further steps are performed depending on the temperature measured.

14. A discharge apparatus comprising:
a plurality of battery connection points arranged in series for discharging at least one battery;
a controller; and
for each respective battery connection point, a switch, a changeover switch, and a short-circuit switch;
wherein the discharge apparatus is configured to:
connect the battery to a vacant battery connection point, the vacant battery connection point being disconnected, at all poles, from a discharge circuit of the discharge apparatus via an open switch and a changeover switch in a first position;
ramp down a current in the discharge circuit;
switch the changeover switch to a second position such that, instead of a connection in the discharge apparatus parallel to and bypassing the battery connection point, a connection at least one of from and to a first pole of the battery connection point becomes enabled to carry current;
close the switch such that a connection in the discharge apparatus at least one of from and to a second pole of the battery connection point becomes enabled to carry current;
discharge the connected battery via a discharge current provided by a controller of the discharge apparatus;
ramp down the current in the discharge circuit;
open the switch; and
switch the changeover switch to the first position such that, instead of the connection at least one of from and to the first pole of the battery connection point, the connection in the discharge apparatus parallel to and bypassing the battery connection point becomes enabled to carry current.

15. The discharge apparatus as claimed in claim 14, further comprising:
a voltage measuring device for each respective battery connection point.

16. The discharge apparatus as claimed in claim 15, further comprising;
a temperature measuring device for each respective battery connection point.

17. The discharge apparatus as claimed in claim 14, wherein the at least one battery comprises a plurality of batteries simultaneously.

18. A discharge apparatus comprising:
a plurality of battery connection points arranged in series for discharging at least one battery; and
a switch arrangement for at least one of connecting and disconnecting an inserted battery at all poles for each battery connection point.

19. The discharge apparatus as claimed in claim 18, further comprising:
a short-circuit switch, for each respective battery connection point, said short-circuit switch short-circuiting an inserted battery which been discharged and disconnected at all poles.

20. The discharge apparatus as claimed in claim 18, wherein the at least one battery comprises a plurality of batteries simultaneously.
